(19) United States
(12) Patent Application Publication
(10) Pub. No.: US 2025/0241299 A1
(43) Pub. Date: Jul. 31, 2025

(54) Polymer Emulson Drift Reduction Adjuvant Formulations

(71) Applicant: Rosen's, Inc., Liberty, MO (US)

(72) Inventor: Matthew T Meredith, Spring, TX (US)

(21) Appl. No.: 19/038,586

(22) Filed: Jan. 27, 2025

Related U.S. Application Data
(60) Provisional application No. 63/625,751, filed on Jan. 26, 2024.

(51) Int. Cl. A01N 25/10; A01N 25/04; A01N 25/30

(52) U.S. Cl. CPC A01N 25/10; A01N 25/04; A01N 25/30

(57) ABSTRACT

To reduce fine particles and improve droplet size distribution, an agrochemical spray includes an aqueous solution having one or more active ingredients and a drift reduction adjuvant formulation, which form a spontaneous emulsion. The drift reduction adjuvant formulation includes a hydrophobic solvent, a high molecular weight polymer dissolved in the solvent, and one or more surfactants to facilitate the emulsion. When sprayed onto a target crop, the high molecular weight polymer increases the extensional viscosity of the agrochemical spray compared to a formulation without the high molecular weight polymer.

### CROSS REFERENCE TO RELATED APPLICATIONS

This patent application claims the benefit of U.S. Provisional Application No. 63/625,751, titled POLYMER EMULSION DRIFT REDUCTION ADJUVANT FORMULATIONS, filed Jan. 26, 2024, the contents of which are expressly incorporated by reference herein.

### TECHNICAL FIELD

The present disclosure generally relates to drift reduction adjuvants. Drift reduction adjuvants are used in agricultural spray applications to modify the droplet size distribution of sprays to reduce fine droplets, thereby reducing off-target applications.

### BACKGROUND

Agricultural spraying by economical and available technologies uses hydraulic spray nozzles that inherently produce a wide spectrum of spray droplet sizes. The potential for these spray droplets to drift from the initial, desired site of application is found to be a function of droplet size, with smaller, fine droplets (generally defined as less than 150 μm in diameter) having a higher propensity for off-target movement, and every nozzle generates some amount of fine droplets.

Drift reduction adjuvants (DRAs) are chemical formulations that are added into the grower's spray tank, typically along with pesticides, and are used to fine-tune the spray droplet pattern and reduce the number of fine droplets generated during spraying. Chemically, these products fall into two primary classes—polymers and emulsions. Certain polymers of sufficient molecular weight, when dissolved or hydrated in the spray solution, modify the extensional viscosity of the spray as it experiences the high shear conditions of a spray nozzle. This increase in viscosity under shear results in less fine droplet formation and typically more large droplet formation.

DRA polymers are water-soluble or water-swellable (hydrocolloids) and in addition to increasing the extensional viscosity of a spray under high shear conditions, can also increase the bulk viscosity of a spray solution, or interact/crosslink with other tank mix additives, which can be undesirable in a tank mixture. Polymer DRAs, while reducing fines, also tend to increase the number of large spray droplets, which is an undesirable side-effect as they bounce or roll off of leaf surfaces easier. Some DRA polymers can break down during tank circulation due to pump shear, which renders them less effective.

Dilute emulsions and/or dilute surfactant vesicles in the spray solution work by a mechanism whereby the emulsion droplets increase the perforation events in the sheets of water that are sprayed out of the nozzle. These DRAs work well with certain types of spray nozzles and certain spray solutions, but changes in fluid spray dynamics between nozzle types and formulations can render them ineffective. In addition, most emulsion-based DRAs have a narrow operating window, e.g., using too much can reverse the desired effects and actually produce more fine particles due to a drop in the solution dynamic surface tension. Because the oil itself typically has adjuvant properties, this is undesirable and limits the amount of oil that can be added to the spray tank. Emulsion DRAs can also be negatively affected or rendered ineffective by other surfactants in the spray solution because the spray-coarsening effect caused by emulsion droplets can be counteracted by a decrease in dynamic surface tension.

While some commercially available DRAs contribute positively to reducing off-target movement of pesticides and improve application control, no single DRA chemistry is sufficient across all types of spray applications and, as such, novel DRA mechanisms and formulations are relevant and beneficial to the agricultural community. Accordingly, it would be desirable to develop DRA formulations useful in reducing agricultural spray drift, and which avoid the problems associated with conventional DRA formulations.

### SUMMARY

The present disclosure generally provides novel drift reduction adjuvant formulations for use in agricultural spray applications to reduce spray drift and off-target applications. The present disclosure further provides novel methods to reduce spray drift during the application of agricultural chemicals by incorporating into the liquid to be sprayed drift reduction adjuvant formulations that modify the droplet size distribution of the spray to reduce fine droplets, thereby reducing agricultural spray drift and off-target applications.

In some examples, the disclosure describes drift reduction adjuvant formulations that include a hydrophobic solvent, a high molecular weight (HMW) polymer dissolved in the solvent, and one or more surfactants. The solvent may be an aliphatic or aromatic hydrocarbon, a halogenated hydrocarbon, a paraffinic oil, naphthenic oil, mineral oil or mixtures thereof. The HMW polymer may have a weight average molecular weight (Mw) or number average molecular weight (Mn) of 400,000 or greater. The high molecular weight polymer may be a polyisobutylene, polystyrene, polyalkynyl succinic anhydride, polyester, polyamide or mixtures thereof. The one or more surfactants act as emulsifiers to emulsify the drift reduction adjuvant formulation when it is added to an aqueous solution of an agricultural spray tank. The emulsifying surfactants may be anionic, nonionic, cationic, or mixtures thereof.

In some examples, the disclosure describes techniques for making an adjuvant formulation. The technique includes dissolving the HWM polymer in a hydrophobic solvent and adding one or more surfactants. The HMW polymer may have weight average molecular weight (Mw) or number average molecular weight (Mn) of 400,000 or greater. In application, the resulting formulation may then be added to a spray tank prior to spraying to emulsify the formulation and mixed with an aqueous solution including one or more active ingredient formulations. The mixture may then be sprayed onto a target plant.

In some examples, the disclosure describes techniques for reducing fine particles in an agrochemical spray. The technique may include adding to a spray tank an aqueous solution and a drift reduction adjuvant formulation to form an emulsion. The drift reduction adjuvant formulation includes a hydrophobic solvent, a high molecular weight polymer dissolved in the solvent, and one or more surfactants. The technique also includes adding one or more active ingredients to the emulsion to form a spray solution and spraying the spray solution onto a target crop. During spraying, the emulsified oil containing the high molecular weight polymer increases the extensional viscosity of the drift reduction adjuvant formulation compared to a formulation without the emulsified oil containing the high molecular weight polymer.

In some examples, the disclosure describes agricultural sprays that includes an aqueous solution having one or more active ingredient formulations and a drift reduction adjuvant formulation. The drift reduction adjuvant formulation includes a hydrophobic solvent, a high molecular weight polymer dissolved in the solvent, and one or more surfactants. The one or more surfactants with the hydrophobic solvent and dissolved high molecular weight polymer form a spontaneous emulsion in the aqueous solutions.

In some examples, the disclosure describes an agricultural spray that includes an aqueous solution, one or more pesticide or crop protection agents, and drift reduction adjuvant formulation. The drift reduction adjuvant formulation includes a hydrophobic solvent, a high molecular weight polymer, and one or more surfactants. The agricultural spray is configured to, when sprayed to produce spray droplets, produce fewer spray droplets having a diameter less than 150 microns compared to a composition comprising the aqueous solution and the one or more pesticide or crop protection agents without the drift reduction adjuvant formulation sprayed under the same conditions.

In some examples, the disclosure describes techniques to reduce spray drift during the application of one or more pesticide or crop protection agents from a spray apparatus. The technique includes incorporating a drift reduction adjuvant formulation into an aqueous solution having one or more pesticide or crop protection agents to produce a spray formulation. The drift reduction adjuvant formulation includes a hydrophobic solvent, a high molecular weight polymer dissolved in the solvent, and one or more surfactants. The technique also includes spraying a volume of the spray formulation from the spray apparatus having a nozzle to produce spray droplets. Upon spraying, the mass median diameter (DV50) of the spray droplets is increased compared to a composition comprising the aqueous solution and the one or more pesticide or crop protection agents without the drift reduction adjuvant formulation sprayed under the same conditions.

Benefits and advantages of adjuvant formulations according to the present disclosure include improved deposition and retention of spray, spray pattern quality, canopy penetration and performance of applied pesticides.

### DETAILED DESCRIPTION

For purposes of promoting an understanding of the principles of the disclosure, reference will now be made to specific examples. It will nonetheless be understood that no limitation of the scope of the disclosure is intended by the description of certain examples of the disclosure. In addition, any alterations and/or modifications of the described examples are contemplated as being within the scope of the present disclosure. Further, any other applications of the principles of the disclosure, as described herein, as would normally occur to one skilled in the art to which the disclosure pertains, are contemplated as being within the scope of the present disclosure.

The present disclosure is generally directed to drift reduction adjuvant (DRA) formulations that reduce spray drift during the application of agricultural chemicals. DRA formulations are typically categorized as polymers or emulsions, or in some cases low-HLB surfactants, as described in U.S. Pat. No. 10,123,532. According to one or more examples, the present disclosure provides DRA formulations including a high molecular weight (HMW) polymer dissolved in a carrier solvent that emulsifies into an agricultural spray solution. It is believed that the HMW polymer modifies the extensional viscosity of its carrier solvent at low concentrations and is emulsified into the spray solution to form dispersed, liquid droplets that contain the dissolved HMW polymer. It has been surprisingly found that this approach is more effective than an equivalent emulsion that does not contain the polymer and has surprising advantages over polymer-based DRA formulations. It is further believed that, because the polymer is emulsified, and not dissolved into the bulk spray solution like other polymeric DRA products, the polymer is surprisingly still able to effectively reduce fine droplets in agricultural sprays. Further, it is believed that, because the polymer is emulsified, the bulk viscosity of the solution does not increase rapidly with higher loadings, as compared to other non-emulsified DRA polymers.

According to one or more examples, the present disclosure provides an adjuvant formulation including a non-water soluble solvent, a HMW polymer dissolved in the solvent, and one or more surfactants. In some examples, the one or more surfactants act as emulsifiers to emulsify the formulation when it is added to an agricultural spray solution, such as an aqueous solution including one or more active ingredient formulations.

With respect to the DRA formulation, in examples, the HMW polymer may be present in a range from approximately 0.1% to approximately 20%, such as within a range from approximately 2% to approximately 5%. In some examples, the HMW polymer has a number average molecular weight (Mn) or a weight average molecular weight of 400,000 or greater, such as 500,000 or greater. A preferred number average molecular weight (Mn) of the HMW polymer is within a range from approximately 200,000 to approximately 1,500,000 such as approximately 800,000 to approximately 1,200,000. A preferred weight average molecular weight of the HMW polymer is within a range from approximately-500,000 to approximately 5,000,000, such as approximately 1,500,000 to approximately 3,000,000.

In some examples, the HMW polymer may include, but is not limited to, at least one of a polyisobutylene, a polystyrene, a polyalkyl succinic anhydride, a polyester, and a polyamide. For example, the HMW polymer may include a polyisobutylene, a polystyrene, or a mixture thereof. In some examples, the HMW polymer is a polyisobutylene. Commercial examples of HMW polyisobutylene polymers include the OPPANOL® N and OPPANOL® C series available from BASF located in Ludwigshafen, Germany.

The one or more surfactants may be present in the DRA formulation in a range from approximately 5% to approximately 40%, such as within a range from approximately 8% to approximately 15%.

In some examples, the one or more surfactants include one or more emulsifying surfactants. Additionally, or alternatively, the surfactants may be anionic, nonionic, cationic, or mixtures thereof. Example surfactants may include, but are not limited to, one or more of fatty acid glycol ester surfactants, polyalkoxylated triglyceride surfactants, alkoxylated fatty alcohol surfactants, sulfosuccinate surfactants, betaine surfactants, carboxylated fatty alcohol alkoxylates, ether sulfates, sorbitan fatty acid ester surfactants, polyalkoxylated alkylphenol surfactants, polyalkoxylated alkarylphenol surfactants, alkoxylated alkylamine surfactants, quaternary ammonium surfactants, alkoxylated tristyrylphenol surfactants, amine oxide surfactants, alkanolamide surfactants, alkyl polyglucoside surfactants, ethylene/propylene block copolymers, and combinations thereof.

In some examples, the hydrophobic solvent may be aliphatic, aromatic, or mixtures thereof. Example hydrophobic solvents may include, but are not limited to, hydrocarbons, halogenated hydrocarbons, paraffinic oils, naphthenic oils, mineral oils, vegetable oils, modified vegetable oils, seed oils, modified soybean oils (e.g., soybean oil methyl ester, methyl soyate), modified palm oils, modified rapeseed oils, crop oil concentrate, aromatic oil, emulsified petroleum distillates, unsaturated fatty acids, tall oil (e.g., fatty acids of tall oil), phytobland-based oil, tallow oil). Modified oils may include oils that are, for instance, methylated, ethylated, propylated, or butylated.

In some examples, the DRA formulation may further contain one or more additives useful in adjuvant formulations used in connection with agrochemically active formulations. For example, the adjuvant formulation may include up to about 1% by weight, or up to about 20% by weight, based on the total weight of the adjuvant formulation, of additive(s). In some examples the additives may include, but are not limited to, chelators (e.g., EDTA), water conditioners, dispersants, emulsifiers, oils, biostimulants (e.g., seaweed extracts (e.g., ascophyllum nodosum), amino acids, chitosan, essential vitamins, dicarboxylic acids, polyamino acids), humic acids (e.g., potassium humate), fulvic acids, myo-inositol, amino acids), anti-settling agents (hydrophobically-modified clays (e.g., sodium montmorillonite where exchangeable sodium ions are replaced with organic cationic molecules, such as, alkylamines), surface modified silicas, fumed silicas (e.g., untreated, or surface-modified)), and fertilizers/micronutrient fertilizers.

In accordance with the present disclosure, the DRA formulation may be produced according to any process known in the art (e.g., mechanically, chemically, enzymatically, etc.). According to one or more examples, the DRA formulation of the present disclosure may be prepared by dissolving an HMW polymer in a hydrophobic solvent and adding one or more surfactants to form the DRA formulation. Also provided is a container, mixing vessel, mixing tank, mixing kettle, or storage tank including the adjuvant formulation of the present disclosure. The DRA formulation, according to the various examples of the present disclosure, may be subsequently combined with an agrochemically active formulation (e.g., an aqueous solution having one or more active ingredients) to produce an agrochemical spray that is subsequently applied to a plant or onto soil in which the plant is growing to improve the growth or development of the plant.

In some examples, the present disclosure provides methods to reduce spray drift during the application of an agrochemical spray including combining one or more of the DRA formulations described herein with an agrochemically active formulation prior to spraying a target crop.

In some examples, the present disclosure includes a method for improving the growth or development of a crop by combining a DRA formulation according to the present disclosure with an agrochemically active formulation and applying the mixture to the crop or onto the soil in which the crop is growing.

In some examples, it is believed that the one or more emulsifying surfactants act as emulsifiers to emulsify the formulation when it is added to the agriculture spray tank and the DRA formulation in the mixture effects a reduction in fine particles in the agrochemical spray.

In some examples, a method of reducing fine particles in an agrochemical spray, including the steps of: preparing a DRA formulation including: a hydrophobic solvent; a high molecular weight polymer dissolved in the solvent, having a number average (Mn) molecular weight of 400,000 or greater; and one or more emulsifying surfactants; adding the DRA formulation to a spray tank including an aqueous solution; adding one or more active ingredient formulations to the tank to form an emulsion of the aqueous solution having the one or more active ingredient formulations and the DRA formulation and; and spraying a volume of the emulsion onto a target crop.

In some examples, the DRA formulation is incorporated into the agrochemical solution in an amount within a range from approximately 0.1 vol % to approximately 5.0 vol. % such as within a range from approximately 0.2 vol. % to approximately 2 vol. % of the spray mixture. According to one or more examples, the one or more active ingredient formulations may include an amount within a range from approximately 0.02 vol % to approximately 5.0 vol. % such as within a range from approximately 0.5 vol. % to approximately 2.0 vol. % of the spray mixture.

The mixture of the DRA formulation and agrochemically active formulation of the present disclosure may be applied according to crop-specific recommendations which will depend upon the application method as well as whether they are applied onto the soil or crop. The mixtures described herein can be applied by various means, including sprays, sprinklers, drips, dips, drenches, dressings, oils, and any type of irrigation system. As non-limiting examples, examples encompass foliar sprays, turf sprays, in-furrow sprays, root dips, root drenches, stem drenches, seedling drenches, tuber drenches, fruit drenches, soil drenches, soil drips, and soil injections.

In some examples, the volume of the mixture of the adjuvant formulation(s) and the one or more active ingredient formulations or agrochemical solutions was sprayed from a spray apparatus including a nozzle to produce spray droplets, where, for a particular nozzle, less than about 0.5% to about 15% of the spray mixture volume formed spray droplets smaller than 150 microns in diameter when measured at a predetermined distance (e.g., between 30 cm to 80 cm) from the tip of the nozzle; and where the mass median diameter (DV50) of the spray droplets formed from the mixture is increased above the mass median diameter of the same one or more active ingredient formulations or agrochemical solution without the DRA formulation, when sprayed from the same spray apparatus and nozzle.

According to one or more examples, the adjuvant formulation may be combined with a pesticide to form an agrochemically active formulation. The pesticide may be any compound (or mixture of compounds) used for crop, plant or livestock protection against unwanted organisms (“pests”). The pesticides may include an insecticide, herbicide, fungicide, acaricide, algicide, antimicrobial agent, biopesticide, biocide, disinfectant, fumigant, insect growth regulator, miticide, microbial pesticide, molluscide, nematicide, ovicide, pheromone, repellent, rodenticide, desiccant, and mixtures thereof. Pests include invertebrates such as insects, mites, slugs, snails, nematodes, flatworms, millipedes, pathogenic protozoa, weeds, fungi, molds, bryophytes, lichens, algae, yeasts, bacteria and viruses, as well as vertebrates such as rodents, rabbits and pigeons. The pesticides further include, but are not limited to organophosphate pesticides, carbamate pesticides, organochlorine insecticides, and pyrethroid pesticides.

In some examples, the one or more active ingredient formulations or agrochemical solution may include fertilizers, pesticides, or mixtures thereof. Examples of fertilizers may include ammonium sulfate, ammonium nitrate, ammonium sulfate nitrate, ammonium chloride, ammonium bisulfate, ammonium polysulfide, ammonium thiosulfate, aqueous ammonia, anhydrous ammonia, ammonium polyphosphate, aluminum sulfate, calcium nitrate, calcium ammonium nitrate, calcium sulfate, calcined magnesite, calcitic limestone, calcium oxide, calcium nitrate, dolomitic limestone, hydrated lime, calcium carbonate, diammonium phosphate, monoammonium phosphate, magnesium nitrate, magnesium sulfate, potassium nitrate, potassium chloride, potassium magnesium sulfate, potassium sulfate, sodium nitrates, magnesian limestone, magnesia, urea, urea-formaldehydes, urea ammonium nitrate, sulfur-coated urea, polymer-coated urea, isobutylidene diurea, K₂SO₄—2MgSO₄, kainite, sylvinite, kieserite, Epsom salts, elemental sulfur, marl, ground oyster shells, fish meal, oil cakes, fish manure, blood meal, rock phosphate, super phosphates, slag, bone meal, wood ash, manure, bat guano, peat moss, compost, green sand, cottonseed meal, feather meal, crab meal, fish emulsion, humic acid, or a combination of any thereof.

Examples of micronutrient fertilizers may include chromium, cobalt, copper, iron, manganese, zinc, boron, chlorine, iodine, molybdenum, selenium or mixtures thereof. In some examples, the liquid aqueous agrochemical formulation may include a divalent metal salt which includes a cation that is the divalent metal (for e.g., Zn, Cu, Co, Mn, Mg, Ca, or Fe) and one or more anions to balance the charge, such as a halide (e.g., chloride), nitrate, sulfate, carboxylate (e.g., acetate, formate, and propanoate), or halogen-substituted carboxylate (e.g., chloroacetate, dichloroacetate, and chloro-substituted propanoate). Examples include, but are not limited to, zinc acetate, copper acetate, nickel acetate, cobalt acetate, iron acetate, manganese acetate, chromium acetate, cadmium acetate, zinc formate, copper formate, nickel formate, cobalt formate, iron formate, manganese formate, cadmium formate, zinc propanoate, copper propanoate, nickel propanoate, cobalt propanoate, iron propanoate, manganese propanoate, cadmium propanoate, zinc chloroacetate, copper chloroacetate, nickel chloroacetate, cobalt chloroacetate, iron chloroacetate, manganese chloroacetate, cadmium chloroacetate, zinc dichloroacetate, copper dichloroacetate, nickel dichloroacetate, cobalt dichloroacetate, iron dichloroacetate, manganese dichloroacetate, cadmium dichloroacetate, zinc chloride, copper chloride, nickel chloride, cobalt chloride, iron chloride, manganese chloride, cadmium chloride, chromium chloride, magnesium chloride, zinc sulfate, copper sulfate, nickel sulfate, cobalt sulfate, iron sulfate, manganese sulfate, cadmium sulfate, zinc nitrate, copper nitrate, nickel nitrate, cobalt nitrate, and iron nitrate.

Crops may include, but are not limited to, any agricultural or horticultural plant grown to satisfy a need, such as for food, aesthetics, industrial use, athletic use (i.e., performance of an athletic event thereon, for example, on turf grass), and sale. Non-limiting examples of potential “crops” to which the aqueous formulations of the present disclosure may be applied to include, but are not limited to, fruits, vegetables, roots and tubers, grains, flowers and other horticultural products, trees, shrubs, turf grass and sod, houseplants, and industrial crops, such as corn, wheat, barley, sunflowers, canola, flax, borage, legumes, sugar beets, and soybeans for the production of industrial and food products.

In addition to the formulations set forth above, the present invention also embraces formulations in combination with one or more additional compatible ingredients. Other additional ingredients may include, for example, one or more other pesticides, dyes, and any other additional ingredients providing functional utility, such as, for example, stabilizers, fragrances, viscosity-lowering additives, and freeze-point depressants.

The following examples illustrate the subject matter described herein, including example DRA formulations and agrochemically active formulations. In the following example, comparative DRA formulations were made by mixing components using a low-shear overhead mixer. Components and raw materials used in the formulations are included in Table 1 below.

| Abbreviation | Description |
|---|---|
| PIB 1 | OPPANOL ® C150, available from BASF |
| PIB 2 | OPPANOL ® C100, available from BASF |
| NEM-1 | ETHSORBOX ® TO-20, available from Ethox Chemical |
| PIB 1 | OPPANOL ® C150, available from BASF |
| PIB 2 | OPPANOL ® C100, available from BASF |
| NEM-1 | ETHSORBOX ® TO-20, available from Ethox Chemical |
| NEM-2 | ETHAL ® LA-4, available from Ethox Chemical |
| AEM-1 | NINATE ® 60E, available from Stepan Chemical |
| FA-1 | Tall oil fatty acid (TOFA) |
| CE-2 | Masterlock ® adjuvant, available from Winfield United |
| CE-3 | Array ® adjuvant, available from Rosen's Inc. |
| ED | Enlist Duo ® Herbicide, available from Corteva |
| XM | XTENDIMAX ® Herbicide, available from Bayer Crop |
| | Science |

Comparative Example 1 (hereinafter, CE-1): For CE-1, the formulation in Table 2 below was prepared by mixing the ingredients using a low-shear overhead mixer. The resulting solution was a homogeneous light-yellow oil.

TABLE 2

| CE-1 Components | Wt. % |
|---|---|
| 7N Paraffinic oil | 85% |
| NEM-1 | 10% |
| AEM-1 | 3% |
| FA-1 | 2% |

Comparative Example 2 (hereinafter, CE-2) included Masterlock® adjuvant, available from Winfield United located in Plainfield, Indiana, is an oil-based drift reduction adjuvant and used as an industry standard.

Comparative Example 3 (hereinafter, CE-3) included Array® adjuvant, available from Rosen's Inc. located in Fairmont, Minnesota, is a guar polymer containing drift reduction adjuvant and used as an industry standard.

Example 1 (hereinafter, EX-1) including the components illustrated in Table 3 was prepared in accordance with the present disclosure. PIB 1 polymer was dissolved in an appropriate amount of 7N paraffinic oil at 80° C. The formulation below was then prepared by mixing the ingredients using a low-shear overhead mixer. The resulting solution was a homogeneous, viscous, light-yellow oil.

TABLE 3

| EX-1 Component | Vol. % |
|---|---|
| 7N Paraffinic oil | 84% |
| NEM-1 | 10% |
| AEM-1 | 3% |
| FA-1 | 2% |
| PIB 1 | 1% |

Spray droplet size analysis: Spray droplet/particle size distribution testing was conducted to compare the formulations of EX-1 (including PIB 1), CE-1, CE-2, and CE-3. Table 4 shows the spray droplet size analysis with multiple nozzle types and different herbicide-containing solutions (or water alone), sprayed in a custom-made spray chamber. The particle size distribution and analysis can be obtained by measurements using ASTM Standard Test Method E2798: “Standard Test Method for Characterization of Performance of Pesticide Spray Drift Reduction Adjuvants for Ground Application”.

TABLE 4

| | | | | | | | Fines | Fines |
|---|---|---|---|---|---|---|---|---|
| Sample | Conc. | Nozzle | Soln. | DV10 | DV50 | DV90 | <105 μm** | <150 μm*** |
| Water | — | AIXR11004 | water | 174.57 | 421.83 | 721.35 | 2.21 | 6.7 |
| CE-1 | 1.00% | AIXR11004 | water | 168.95 | 425.75 | 729.93 | 2.73 | 7.45 |
| EX-1 | 1.00% | AIXR11004 | water | 202.74 | 450 | 754.43 | 0.94 | 4 |
| Water | — | AIXR11004 | ED | 194.39 | 428.72 | 689.38 | 1.74 | 5.02 |
| CE-1 | 0.50% | AIXR11004 | ED | 177.56 | 409.1 | 698.61 | 2.19 | 6.41 |
| CE-1 | 1.00% | AIXR11004 | ED | 189.2 | 406.54 | 674.11 | 1.33 | 4.88 |
| EX-1 | 0.50% | AIXR11004 | ED | 185.54 | 415.87 | 699.94 | 1.66 | 5.46 |
| EX-1 | 1.00% | AIXR11004 | ED | 201.58 | 434.43 | 694.78 | 1.36 | 4.31 |
| CE-2 | 0.50% | AIXR11004 | ED | 189.54 | 406.88 | 656.33 | 1.75 | 5.23 |
| CE-2 | 1.00% | AIXR11004 | ED | 173.98 | 375.92 | 616.45 | 2.47 | 6.7 |
| Water | — | TTI11004 | water | 284.72 | 660.34 | 1022.52 | 0.47 | 1.72 |
| CE-1 | 1.00% | TTI11004 | water | 294.62 | 657.24 | 1046.64 | 0.3 | 1.35 |
| EX-1 | 1.00% | TTI11004 | water | 312.94 | 681.31 | 1053.33 | 0.24 | 1.07 |
| Water | — | TTI11004 | XM | 300.51 | 668.07 | 1045.17 | 0.33 | 1.39 |
| CE-1 | 1.00% | TTI11004 | XM | 301.79 | 682.45 | 1047.87 | 0.23 | 1.17 |
| EX-1 | 1.00% | TTI11004 | XM | 323.43 | 699.2 | 1072.56 | 0.2 | 0.98 |

**Percent of spray volume with droplet size less than 105 μm
***Percent of spray volume with droplet size less than 150 μm

Table 5 shows the spray droplet size analysis with multiple nozzle types, sprayed in a wind tunnel at an air speed of 15 mph, using a Sympatec particle size analyzer.

TABLE 5

| Treatment | | | | | | | | | |
|---|---|---|---|---|---|---|---|---|---|
| Description | Rate | | Nozzle | Dv10 | Dv50 | Dv90 | RS | <105 μm** | <141 μm*** |
| Water | — | | AIXR11004 | 215.54 | 449.99 | 718.26 | 1.12 | 1.17 | 3.31 |
| CE-3 | 9 lbs/100 gal | | AIXR11004 | 252.83 | 560.33 | 928.68 | 1.21 | 1.1 | 2.48 |
| CE-2 | 4 | oz/Ac | AIXR11004 | 248.49 | 466.6 | 690.44 | 0.95 | 0.81 | 2.08 |
| CE-2 | 2 | oz/Ac | AIXR11004 | 249.12 | 469.27 | 707.14 | 0.98 | 0.79 | 2.04 |
| EX-1 | 1 | pt/Ac | AIXR11004 | 260.13 | 524.31 | 824.42 | 1.08 | 0.45 | 1.59 |
| Water | — | | TT11004 | 143.34 | 325.83 | 581.29 | 1.34 | 3.57 | 9.62 |
| CE-3 | 9 lbs/100 gal | | TT11004 | 211.81 | 480.54 | 786.88 | 1.2 | 1.72 | 4.13 |
| EX-1 | 1 | pt/Ac | TT11004 | 158.68 | 343.37 | 594.9 | 1.27 | 2.27 | 7.15 |
| EX-1 | 0.25 | pt/Ac | TT11004 | 147.57 | 313.07 | 556.39 | 1.31 | 2.87 | 8.88 |
| CE-1 | 0.25 | pt/Ac | TT11004 | 140.73 | 296.15 | 499.52 | 1.21 | 3.4 | 10.05 |
| CE-2 | 4 | oz/Ac | TT11004 | 138.78 | 293.07 | 505.08 | 1.25 | 3.74 | 10.43 |
| Water | — | | TTI11004 | 338.37 | 688.45 | 1049.95 | 1.03 | 0.12 | 0.63 |
| CE-3 | 9 lbs/100 gal | | TTI11004 | 496.58 | 922.81 | 1246.43 | 0.81 | 0 | 0.19 |
| EX-1 | 1 | pt/Ac | TTI11004 | 392.99 | 752.62 | 1054.2 | 0.88 | 0.02 | 0.28 |
| EX-1 | 0.5 | pt/Ac | TTI11004 | 347.58 | 689.44 | 1078.89 | 1.06 | 0.07 | 0.49 |
| EX-1 | 0.25 | pt/Ac | TTI11004 | 352.45 | 697.73 | 1090.09 | 1.06 | 0.06 | 0.45 |
| CE-1 | 0.25 | pt/Ac | TTI11004 | 324.83 | 647.22 | 1033.06 | 1.09 | 0.15 | 0.7 |
| CE-2 | 4 | oz/Ac | TTI11004 | 312.24 | 610.17 | 959.72 | 1.06 | 0.2 | 0.87 |

**Percent of spray volume with droplet size less than 105 μm
***Percent of spray volume with droplet size less than 141 μm

As illustrated above, the formulations according to the present disclosure (EX-1) consistently lowered the number of fine particles to a greater extent than both water alone and the CE-1 (the same composition of EX-1 without the high molecular weight polymer). The above testing further illustrates that, in accordance with the present disclosure, HMW polymer(s) dissolved in oil has a strong effect on the dynamics of the spray as it exits the nozzle. In addition, unlike most emulsion-based DRA products that exhibit an increase in fine particles with increasing use rates (as exhibited by CE-1 and CE-2), the formulations according to the present disclosure have the opposite effect, in that, increasing its use rate consistently produces fewer fine droplets. As illustrated in Tables 4 and 5 above, the formulations according to the present disclosure exhibited superior effectiveness in increasing deposition and reducing drift, thereby enhancing pesticide performance as compared to the formulations.

In the context of this disclosure, a number of terms are used. The following definitions of various terms are provided below. Other definitions can be found throughout the disclosure. It is understood that the definitions provided below are the preferred definitions for the purposes of describing the present disclosure unless it is stated otherwise herein or apparent from the context of usage.

If appearing herein, the term “including” and derivatives thereof are not intended to exclude the presence of any additional component, step, or procedure, whether or not the same is disclosed herein. In order to avoid any doubt, all compositions claimed herein through use of the term “including” may include any additional additive, adjuvant, or compound, unless stated to the contrary. In contrast, the term, “consisting essentially of” if appearing herein, excludes from the scope of any succeeding recitation any other component, step, or procedure, except those that are not essential to operability and the term “consisting of”, if used, excludes any component, step or procedure not specifically delineated or listed. The terms “or” and “and/or”, unless stated otherwise, refer to the listed members individually as well as in any combination. For example, the expression A or B refers to A alone, B alone, or to both A and B.

The articles “a” and “an” are used herein to refer to one or to more than one (i.e., to at least one) of the grammatical objects of the article. The phrases “in one example,” “according to one example,” in some examples,” and the like generally mean the feature, structure, or characteristic following the phrase is included in at least one example of the present disclosure and may be included in more than one example of the present disclosure. Importantly, such phrases do not necessarily refer to the same example. If the specification states a component or feature “may,” “can,” “could,” or “might” be included or have a characteristic, that component or feature is not required to be included or have the characteristic.

The terms “about” and “approximately” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The term “optional” or “optionally” means that the subsequently described event or circumstance may or may not occur, and that the description includes instances where said event or circumstance occurs and instances where it does not.

The meaning of an “adjuvant” according to the present disclosure is understood to be in accordance with the definition of an adjuvant given by ASTM International, section E1519-16: A material added to a tank mix to aid or modify the action of an agrichemical, or the physical characteristics of the mixture.

U.S. Pat. Nos. 5,550,224; 6,288,010; 5,824,797; 11,612,164; 10,123,532; 6,797,673; 11,172,679; 9,907,303; 10,123,532; 6,214,771; 4,481,077; 4,374,702; 4,341,807; 5,688,750; 5,707,945; 3,912,642; 5,219,479; and 4,559,226 are hereby incorporated by reference herein in their entireties for all purposes. In addition, U.S. Publication Nos.: 2014/0106972 and 2013/0123104 are hereby incorporated by reference herein in its entirety for all purposes. International Patent publications WO 2007/091942, WO 2022/189654, WO2015/180844, WO1990/005714, WO 2005/071050, and WO 1996/022109 and EP3444282A1 are hereby incorporated by reference herein in their entireties for all purposes. Components, devices, formulations, compositions, processes and methods illustrated in such patents may be utilized with examples herein.

The patents, patent publications and other references mentioned above in all sections of this application are herein incorporated by reference in their entirety for all purposes. All the features disclosed in this specification (including the references incorporated by reference, including any accompanying claims, abstract and drawings), and/or all of the steps of any method or process so disclosed, may be combined in any combination, except combinations where at least some of such features and/or steps are mutually exclusive. The invention is not restricted to the details of the foregoing example(s). The invention extends to any novel one, or any novel combination, of the features disclosed in this specification (including any incorporated by reference references, any accompanying claims, abstract and), or to any novel one, or any novel combination, of the steps of any method or process so disclosed.

The following clauses illustrate example subject matter described herein:

Clause 1. An agricultural spray drift reduction adjuvant formulation, the formulation comprising: a hydrophobic solvent; a high molecular weight polymer dissolved in the solvent; and one or more surfactants.

Clause 2. The formulation of clause 1, wherein the high molecular weight polymer has a number average molecular weight (Mn) between 500,000 and 1,500,000 or weight average molecular weight (Mw) between 1,000,000 and 5,000,000.

Clause 3. The formulation of clause 1 or 2, wherein the high molecular weight polymer is selected from the group consisting of polyisobutylene, polystyrene, and mixtures thereof.

Clause 4. The formulation of any one of clauses 1 through 3, wherein the high molecular weight polymer increases the extensional viscosity of the formulation compared to a formulation without the high molecular weight polymer.

Clause 5. The formulation of any one of clauses 1 through 4, wherein the hydrophobic solvent comprises an aliphatic hydrocarbon.

Clause 6. The formulation of any one of clauses 1 through 5, wherein the hydrophobic solvent comprises an aromatic hydrocarbon.

Clause 7. The formulation of any one of clauses 1 through 6, wherein the hydrophobic solvent is selected from the group consisting of fatty acid alkyl esters, vegetable oils, and mixtures thereof.

Clause 8. The formulation of any one of clauses 1 through 7, wherein the hydrophobic solvent comprises a mixture of two or more hydrophobic solvents.

Clause 9. The formulation of any one of clauses 1 through 8, wherein the surfactants comprise a mixture of at least one anionic surfactant and at least one nonionic surfactant.

Clause 10. The formulation of any one of clauses 1 through 9, wherein the formulation is configured to form a spontaneous emulsion when added to an aqueous solution.

Clause 11. A method of reducing fine particles in an agrochemical spray, wherein the method comprises: adding to a spray tank an aqueous solution and a drift reduction adjuvant formulation to form an emulsion, wherein the drift reduction adjuvant formulation comprises: a hydrophobic solvent; a high molecular weight polymer dissolved in the solvent; and one or more surfactants; adding one or more active ingredients to the emulsion to form a spray solution; and spraying the spray solution onto a target crop, wherein the high molecular weight polymer increases the extensional viscosity of the drift reduction adjuvant formulation compared to a formulation without the high molecular weight polymer.

Clause 12. The method of clause 11, wherein the agricultural spray is configured to, when sprayed, produce fewer droplets less than 150 microns in diameter compared to an agricultural spray without the drift reduction adjuvant formulation sprayed under the same conditions.

Clause 13. The method of clause 11 or 12, wherein the high molecular weight polymer has a number average molecular weight (Mn) or weight average molecular weight (Mw) of 500,000 or greater, and wherein the high molecular weight polymer comprises at least one of polyisobutylene and polystyrene.

Clause 14. The method of any one of clauses 11 through 13, wherein the hydrophobic solvent comprises at least one of an aliphatic hydrocarbon, an aromatic hydrocarbon, a fatty acid alkyl esters, and a vegetable oil.

Clause 15. The method of any one of clauses 11 through 14, wherein the surfactants comprise a mixture of at least one anionic surfactant and at least one nonionic surfactant.

Clause 16. An agricultural spray, comprising: an aqueous solution; one or more active ingredient formulations; and a drift reduction adjuvant formulation, the drift reduction adjuvant formulation comprising: a hydrophobic solvent; a high molecular weight polymer dissolved in the solvent; and one or more surfactants, wherein the one or more surfactants with the hydrophobic solvent and dissolved high molecular weight polymer form a spontaneous emulsion in the aqueous solutions.

Clause 17. The agricultural spray of clause 16, wherein an amount of the high molecular weight polymer is within a range from approximately 0.5 volume percent (vol. %) to approximately 5.0 vol. % of the drift reduction adjuvant formulation.

Clause 18. The agricultural spray of clause 16 or 17, wherein an amount of the one or more surfactants is within a range from approximately 8 vol. % to approximately 40 vol. % of the drift reduction adjuvant formulation.

Clause 19. The agricultural spray of any one of clauses 16 through 18, wherein an amount of the drift reduction adjuvant formulation is within a range from approximately 0.1 vol. % to approximately 5 vol. % of the agricultural spray.

Clause 20. The agricultural spray of any one of clauses 16 through 19, wherein the high molecular weight polymer has a number average molecular weight (Mn) or weight average molecular weight (Mw) of 500,000 or greater, and wherein the high molecular weight polymer comprises at least one of polyisobutylene and polystyrene.

Clause 21. The agricultural spray of any one of clauses 16 through 20, wherein the one or more surfactants comprises a mixture of at least one anionic surfactant and at least one nonionic surfactant.

Clause 22. The agricultural spray of any one of clauses 16 through 21, wherein the hydrophobic solvent comprises at least one of a fatty acid alkyl ester and a vegetable oil.

Clause 23. The agricultural spray of any one of clauses 16 through 22, wherein, when sprayed, the agricultural spray is configured to form dispersed, liquid droplets that contain the dissolved high molecular weight polymer.

Clause 24. An agricultural spray, comprising: an aqueous solution, one or more pesticide or crop protection agents; and a drift reduction adjuvant formulation, comprising: a hydrophobic solvent; a high molecular weight polymer; and one or more surfactants, wherein the agricultural spray is configured to, when sprayed to produce spray droplets, produce fewer spray droplets having a diameter less than 150 microns compared to a composition comprising the aqueous solution and the one or more pesticide or crop protection agents without the drift reduction adjuvant formulation sprayed under the same conditions.

Clause 25. The agricultural spray of clause 24, wherein the agricultural spray is configured to increase the mass mean diameter (DV50) of spray droplets compared to the composition comprising the aqueous solution and the one or more pesticide or crop protection agents without the drift reduction adjuvant formulation sprayed under the same conditions.

Clause 26. The agricultural spray of clause 24 or 25, wherein an amount of the high molecular weight polymer is within a range from approximately 0.5 volume percent (vol. %) to approximately 5.0 vol. % of the drift reduction adjuvant formulation.

Clause 27. The agricultural spray of any one of clauses 24 through 26, wherein an amount of the one or more surfactants is within a range from approximately 8 vol. % to approximately 40 vol. % of the drift reduction adjuvant formulation.

Clause 28. The agricultural spray of any one of clauses 24 through 27, wherein an amount of the drift reduction adjuvant formulation is within a range from approximately 0.1 vol. % to approximately 5 vol. % of the agricultural spray.

Clause 29. The agricultural spray of any one of clauses 24 through 28, wherein the high molecular weight polymer has a number average molecular weight (Mn) or weight average molecular weight (Mw) of 500,000 or greater, and wherein the high molecular weight polymer comprises at least one of polyisobutylene and polystyrene.

Clause 30. The agricultural spray of any one of clauses 24 through 29, wherein the one or more surfactants comprises a mixture of at least one anionic surfactant and at least one nonionic surfactant.

Clause 31. The agricultural spray of any one of clauses 24 through 30, wherein the hydrophobic solvent comprises at least one of a fatty acid alkyl ester and a vegetable oil.

Clause 32. A method to reduce spray drift during the application of one or more pesticide or crop protection agents from a spray apparatus, wherein the method comprises: incorporating a drift reduction adjuvant formulation into an aqueous solution comprising one or more pesticide or crop protection agents to produce a spray formulation, wherein the drift reduction adjuvant formulation comprises: a hydrophobic solvent; a high molecular weight polymer dissolved in the solvent; and one or more surfactants; and spraying a volume of the spray formulation from the spray apparatus comprising a nozzle to produce spray droplets, wherein the mass median diameter (DV50) of the spray droplets is increased compared to a composition comprising the aqueous solution and the one or more pesticide or crop protection agents without the drift reduction adjuvant formulation sprayed under the same conditions.

Clause 33. The method of clause 26, wherein the fraction of droplets smaller than 150 microns in diameter without the adjuvant formulation is greater than the fraction of droplets smaller than 150 microns in diameter with the adjuvant formulation, measured with a laser diffraction droplet sizing system, with the nozzle 30 cm to 80 cm away from the path of the laser.

Clause 34. The agricultural spray of clause 32 or 33, wherein an amount of the high molecular weight polymer is within a range from approximately 0.5 volume percent (vol. %) to approximately 5.0 vol. % of the drift reduction adjuvant formulation.

Clause 35. The agricultural spray of any one of clauses 32 through 34, wherein an amount of the one or more surfactants is within a range from approximately 8 vol. % to approximately 40 vol. % of the drift reduction adjuvant formulation.

Clause 36. The agricultural spray of any one of clauses 32 through 35, wherein an amount of the drift reduction adjuvant formulation is within a range from approximately 0.1 vol. % to approximately 5 vol. % of the agricultural spray.

Clause 37. The agricultural spray of any one of clauses 32 through 36, wherein the high molecular weight polymer has a number average molecular weight (Mn) or weight average molecular weight (Mw) of 500,000 or greater, and wherein the high molecular weight polymer comprises at least one of polyisobutylene and polystyrene.

Clause 38. The agricultural spray of any one of clauses 32 through 37, wherein the one or more surfactants comprises a mixture of at least one anionic surfactant and at least one nonionic surfactant.

Clause 39. The agricultural spray of any one of claims 32 through 38, wherein the hydrophobic solvent comprises at least one of a fatty acid alkyl ester and a vegetable oil.

The descriptions of the various examples of the present disclosure have been presented for purposes of illustration but are not intended to be exhaustive or limited to the examples disclosed. While the foregoing is directed to examples of the present disclosure, other and further examples of the disclosure may be devised without departing from the basic scope thereof, and the scope thereof is determined by the claims that follow.

What is claimed is:

1. An agricultural spray drift reduction adjuvant formulation, the formulation comprising:
a hydrophobic solvent;
a high molecular weight polymer dissolved in the solvent; and
one or more surfactants.

2. The formulation of claim 1, wherein the high molecular weight polymer has a number average molecular weight (Mn) between 500,000 and 1,500,000 or weight average molecular weight (Mw) between 1,000,000 and 5,000,000.

3. The formulation of claim 1, wherein the high molecular weight polymer is selected from the group consisting of polyisobutylene, polystyrene, and mixtures thereof.

4. The formulation of claim 1, wherein the high molecular weight polymer increases the extensional viscosity of the formulation compared to a formulation without the high molecular weight polymer.

5. The formulation of claim 1, wherein the hydrophobic solvent comprises an aliphatic hydrocarbon.

6. The formulation of claim 1, wherein the hydrophobic solvent comprises an aromatic hydrocarbon.

7. The formulation of claim 1, wherein the hydrophobic solvent is selected from the group consisting of fatty acid alkyl esters, vegetable oils, and mixtures thereof.

8. The formulation of claim 1, wherein the hydrophobic solvent comprises a mixture of two or more hydrophobic solvents.

9. The formulation of claim 1, wherein the surfactants comprise a mixture of at least one anionic surfactant and at least one nonionic surfactant.

10. The formulation of claim 1, wherein the formulation is configured to form a spontaneous emulsion when added to an aqueous solution.

11. A method of reducing fine particles in an agrochemical spray, wherein the method comprises:
adding to a spray tank an aqueous solution and a drift reduction adjuvant formulation to form an emulsion, wherein the drift reduction adjuvant formulation comprises:
a hydrophobic solvent;
a high molecular weight polymer dissolved in the solvent; and
one or more surfactants;
adding one or more active ingredients to the emulsion to form a spray solution; and
spraying the spray solution onto a target crop, wherein the high molecular weight polymer increases the extensional viscosity of the drift reduction adjuvant formulation compared to a formulation without the high molecular weight polymer.

12. The method of claim 11, wherein the agricultural spray is configured to, when sprayed, produce fewer droplets less than 150 microns in diameter compared to an agricultural spray without the drift reduction adjuvant formulation sprayed under the same conditions.

13. The method of claim 11, wherein the high molecular weight polymer has a number average molecular weight (Mn) or weight average molecular weight (Mw) of 500,000 or greater, and wherein the high molecular weight polymer comprises at least one of polyisobutylene and polystyrene.

14. The method of claim 11, wherein the hydrophobic solvent comprises at least one of an aliphatic hydrocarbon, an aromatic hydrocarbon, a fatty acid alkyl esters, and a vegetable oil.

15. The method of claim 11, wherein the surfactants comprise a mixture of at least one anionic surfactant and at least one nonionic surfactant.

16. An agricultural spray, comprising:
an aqueous solution;
one or more active ingredient formulations; and
a drift reduction adjuvant formulation, the drift reduction adjuvant formulation comprising:
a hydrophobic solvent;
a high molecular weight polymer dissolved in the solvent; and
one or more surfactants, wherein the one or more surfactants with the hydrophobic solvent and dissolved high molecular weight polymer form a spontaneous emulsion in the aqueous solutions.

17. The agricultural spray of claim 16, wherein an amount of the high molecular weight polymer is within a range from approximately 0.5 volume percent (vol. %) to approximately 5.0 vol. % of the drift reduction adjuvant formulation, wherein an amount of the one or more surfactants is within a range from approximately 8 vol. % to approximately 40 vol. % of the drift reduction adjuvant formulation, and wherein an amount of the drift reduction adjuvant formulation is within a range from approximately 0.1 vol. % to approximately 5 vol. % of the agricultural spray.

18. The agricultural spray of claim 16, wherein the high molecular weight polymer has a number average molecular weight (Mn) or weight average molecular weight (Mw) of 500,000 or greater, and wherein the high molecular weight polymer comprises at least one of polyisobutylene and polystyrene.

19. The agricultural spray of claim 16, wherein the agricultural spray is configured to, when sprayed to produce spray droplets, produce fewer spray droplets having a diameter less than 150 microns compared to a composition comprising the aqueous solution and the one or more active ingredient formulations without the drift reduction adjuvant formulation sprayed under the same conditions.

20. The agricultural spray of claim 16, wherein the agricultural spray is configured to increase the mass mean diameter (DV50) of spray droplets compared to the composition comprising the aqueous solution and the one or more active ingredient formulations without the drift reduction adjuvant formulation sprayed under the same conditions.
